(19) United States
(12) Patent Application Publication
(10) Pub. No.: US 2026/0091361 A1
(43) Pub. Date: Apr. 2, 2026

(54) GAS MIXER

(71) Applicant: NATIONAL TAIPEI UNIVERSITY of TECHNOLOGY, Taipei City (TW)

(72) Inventors: Da-Sheng LEE, Taipei City (TW); Shang-Tse LEE, Taipei City (TW); Yen-Tang CHEN, Taipei City (TW)

(21) Appl. No.: 18/974,633

(22) Filed: Dec. 9, 2024

(30) Foreign Application Priority Data
Sep. 30, 2024 (TW) 113137451

(51) Int. Cl. B01F 25/312; B01F 23/10; B01F 25/313; B01F 101/00

(52) U.S. Cl. CPC B01F 25/312521; B01F 23/19; B01F 25/31242; B01F 25/3133; B01F 2101/501; B01F 2215/0422

(57) ABSTRACT

A gas mixer includes a housing and a gas intake pipe. The housing has a main body, a first gas intake passage, a second gas intake passage, and a gas outlet passage. The first gas intake passage, the second gas intake passage, and the gas outlet passage are connected to the main body. A central axis of the first gas intake passage and a central axis of the second gas intake passage extend and intersect with each other. The gas intake pipe is movably coupled to the first gas intake passage of the housing, so that a front end of the gas intake pipe is configured to extend to over the second gas intake passage through the first gas intake passage.

### CROSS - REFERENCE TO RELATED APPLICATION

This application claims priority to Taiwan Application Serial Number 113137451, filed September 30, 2024, which is herein incorporated by reference.

### BACKGROUND

### Technical Field

The present disclosure relates to a gas mixer. More particularly, the present disclosure relates to a gas mixer suitable for mixing hydrogen and natural gas.

### Description of Related Art

In the face of global energy shortages and environmental pollution, the technology for replacing fossil fuels with clean energy has gradually received attention. More particularly, since industrial boilers are energy-intensive equipment that consumes a large amount of fossil fuels, the improvement and upgrading of processes and equipment related to the industrial boilers are urgent. For example, carbon emissions can be reduced by using a mixture of natural gas and hydrogen as fuel for the industrial boilers. However, combustion properties of the fuel change after natural gas is mixed with hydrogen. As a result, in order to improve combustion efficiency and reduce pollutant emissions, precise control over the supply and mixing of natural gas and hydrogen is essential.

Accordingly, how to provide a gas mixer to solve the aforementioned problems becomes an important issue to be solved by those in the industry.

### SUMMARY

An aspect of the disclosure is to provide a gas mixer that may efficiently solve the aforementioned problems.

According to an embodiment of the disclosure, a gas mixer includes a housing and a gas intake pipe. The housing has a main body, a first gas intake passage, a second gas intake passage, and a gas outlet passage. The first gas intake passage, the second gas intake passage, and the gas outlet passage are connected to the main body. A central axis of the first gas intake passage and a central axis of the second gas intake passage extend and intersect with each other. The gas intake pipe is movably coupled to the first gas intake passage of the housing, so that a front end of the gas intake pipe is configured to extend to over the second gas intake passage through the first gas intake passage.

In an embodiment of the disclosure, the front end of the gas intake pipe is configured to move within a range. The range has a width along a direction that is substantially perpendicular to the central axis of the second gas intake passage. The width is greater than an inner diameter of the second gas intake passage.

In an embodiment of the disclosure, an inner diameter of the second gas intake passage is greater than an inner diameter of the first gas intake passage and is greater than an inner diameter of the gas outlet passage.

In an embodiment of the disclosure, a first gas flows into the main body through the gas intake pipe. A second gas flows into the main body through the second gas intake passage. A first intake pressure of the first gas is greater than a second intake pressure of the second gas.

In an embodiment of the disclosure, a first gas flows into the main body through the gas intake pipe. A second gas flows into the main body through the second gas intake passage. A second intake flow rate of the second gas is less than a first intake flow rate of the first gas.

In an embodiment of the disclosure, the gas intake pipe has an external thread. The first gas intake passage has an internal thread configured to engage with the external thread of the gas intake pipe.

In an embodiment of the disclosure, the gas outlet passage is connected to the main body through a convergent portion. A cross-sectional area of a first end of the convergent portion that is connected to the main body is greater than a cross-sectional area of a second end of the convergent portion that is connected to the gas outlet passage.

In an embodiment of the disclosure, a central axis of the convergent portion substantially coincides with the central axis of the first gas intake passage.

In an embodiment of the disclosure, the front end of the gas intake pipe is configured to extend at least partially into the convergent portion.

In an embodiment of the disclosure, an included angle between the central axis of the first gas intake passage and the central axis of the second gas intake passage is in a range from 60 degrees to 120 degrees.

In an embodiment of the disclosure, an inner diameter of the second gas intake passage is greater than an inner diameter of the first gas intake passage and is greater than an inner diameter of the gas outlet passage.

According to another embodiment of the disclosure, a gas mixer includes a housing and a gas intake pipe. The housing has a main body, a first gas intake passage, a gas outlet passage, and a second gas intake passage. The first gas intake passage is connected to a first end of the main body. The gas outlet passage is connected to a second end of the main body through a convergent portion. The second gas intake passage is connected to a third end of the main body. The second end is opposite to the first end. The third end is between the first end and the second end. The gas intake pipe is movably coupled to the first gas intake passage of the housing and configured to extend at least partially into the convergent portion.

In an embodiment of the disclosure, the gas intake pipe has an external thread. The first gas intake passage has an internal thread configured to engage with the external thread of the gas intake pipe.

In an embodiment of the disclosure, a central axis of the convergent portion substantially coincides with a central axis of the gas intake passage.

In an embodiment of the disclosure, an inner diameter of the second gas intake passage is greater than an inner diameter of the first gas intake passage and is greater than an inner diameter of the gas outlet passage.

Accordingly, in the gas mixer of some embodiments of the present disclosure, a first gas intake passage and a second gas intake passage with their central axes extending and intersecting are provided. Meanwhile, the gas intake pipe is movably coupled to the first gas intake passage. As a result, the front end of the gas intake pipe can extend over the second gas intake passage, so that the first gas may directly meet and mix with the second gas passing through the second gas intake passage after the first gas passes through the first gas intake passage and leaves the gas intake pipe. In addition, a convergent portion is disposed between the main body and the gas outlet passage. In this way, when the front end of the gas intake pipe extends over the second gas intake passage and into the convergent portion, the Venturi effect can be applied to adjust the mixing ratio of the first gas and the second gas. Therefore, compared with common gas mixers, the gas mixer of the present disclosure enables more precise control over gas mixing, thereby mitigating the issue of poor combustion efficiency caused by changes in gas composition.

It is to be understood that both the foregoing general description and the following detailed description are by examples and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a three-dimensional schematic diagram of a gas mixer according to some embodiments of the present disclosure;

FIG. 2 is a partial cross-sectional view of a gas mixer according to some embodiments of the present disclosure;

FIG. 3 is a partial cross-sectional view of a first gas intake passage and a gas intake pipe of a gas mixer according to some embodiments of the present disclosure; and

FIG. 4 and FIG. 5 are partial cross-sectional views of a gas mixer according to some other embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

Further, spatially relative terms, such as “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Facing global energy shortages and environmental pollution, the industry is exploring the use of hydrogen fuel to replace some fossil fuels such as natural gas for co-firing, which may be applied in industrial boilers and gas turbines with high carbon emissions in order to reduce overall pollutant emissions. However, due to the properties of hydrogen such as high heating value and high burning velocity, the combustion properties of a mixture of natural gas and hydrogen may be quite different from natural gas alone. For example, the addition of hydrogen may result in a shortened flame structure and an increased temperature gradient within the furnace. In addition, part of the source of hydrogen is process waste gas. Therefore, the proportion of hydrogen in the pipeline may fluctuate greatly, resulting in unstable calorific value of the mixed gas. Thus, in order to increase combustion efficiency and reduce pollutant emissions, the supply and mixing of natural gas and hydrogen need to be more precisely controlled to meet both heating capacity requirements and environmental regulations.

Accordingly, the present disclosure aims to provide a gas mixer that can be used to mix unstable multi-fuels (e.g., hydrogen fuel derived from process waste gas) with stable base load fuels (e.g., fossil fuels), so that the mixed gas can be directly introduced into traditional industrial boilers for combustion. In this way, pollutant emissions can be reduced by adjusting the fuel intake volume and fuel composition ratio without modifying the existing boiler equipment.

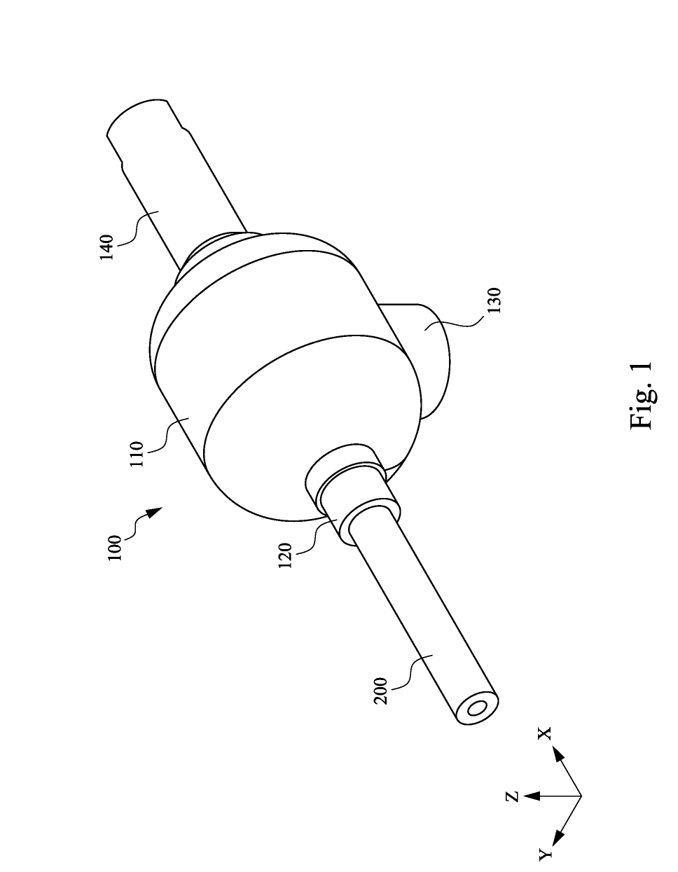

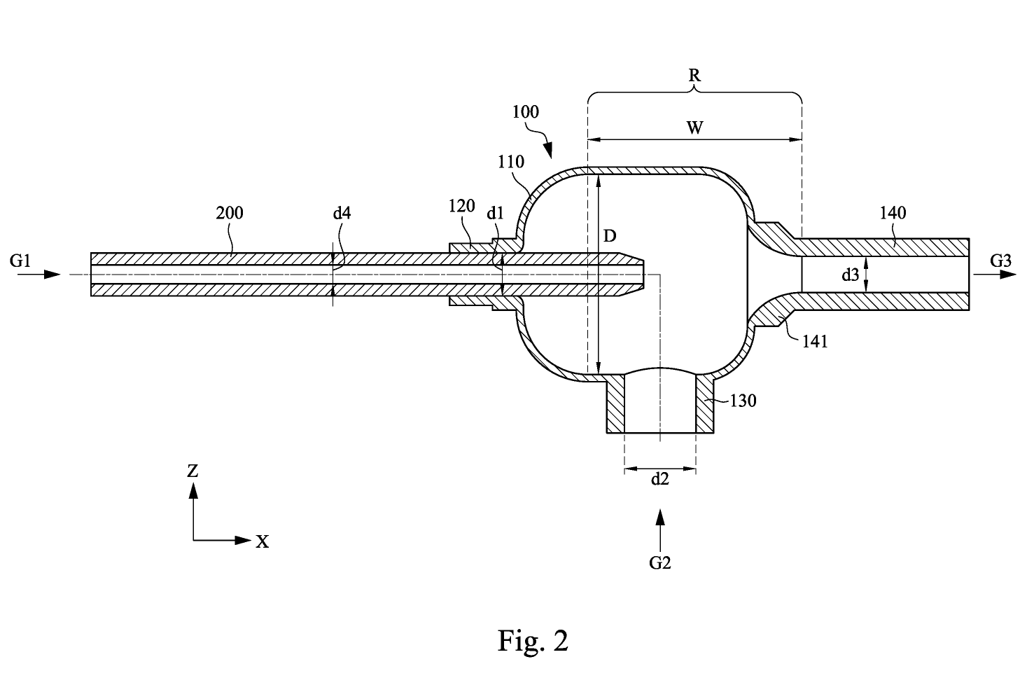

Reference is made to FIG. 1 and FIG. 2. FIG. 1 is a three-dimensional schematic diagram of a gas mixer 10 according to some embodiments of the present disclosure. FIG. 2 is a partial cross-sectional view of the gas mixer 10 according to some embodiments of the present disclosure.

As shown in FIG. 1 and FIG. 2, the gas mixer 10 includes a housing 100. The housing 100 has a main body 110, a first gas intake passage 120, a second gas intake passage 130, and a gas outlet passage 140. The first gas intake passage 120, the second gas intake passage 130, and the gas outlet passage 140 are connected to the main body 110. In some embodiments, as shown in FIG. 2, the main body 110 approximates a cylinder. A first end of the main body 110 is connected to the first gas intake passage 120, and a second end of the main body 110 that is opposite to the first end is connected to the gas outlet passage 140 through a convergent portion 141. The cross-sectional area of the convergent portion 141 tapers along a direction X. In other words, a cross- sectional area of a first end of the convergent portion 141 that is connected to the main body 110 is greater than a cross-sectional area of a second end of the convergent portion 141 that is connected to the gas outlet passage 140 and opposite to the first end of the convergent portion 141, as shown in FIG. 2. The second gas intake passage 130 is connected to the bottom (i.e., a third end) of the main body 110.

In some embodiments, as shown in FIG. 2, the first gas intake passage 120 is configured for a first gas G1 to flow through and into the main body 110 along the direction X. The second gas intake passage 130 is configured for a second gas G2 to flow from bottom to top and into the main body 110 along a direction Z. The first gas G1 and the second gas G2 are mixed in the main body 110 to form a mixed gas G3. The mixed gas G3 flows out of the main body 110 along the direction X through the gas outlet passage 140. In some embodiments, the gas mixer 10 is coupled to an external combustion chamber such as an industrial boiler (not shown). As such, the mixed gas G3 flows into the combustion chamber through the gas outlet passage 140.

In some embodiments, the first gas G1 includes hydrogen, and the second gas G2 includes oxygen and natural gas such as methane (CH₄) and a small amount of ethane (C₂H₆), propane (C₃H₈), butane (C₄H₁₀), and other hydrocarbons. In some other embodiments, the first gas G1 may include hydrogen and natural gas, and the second gas G2 may include oxygen.

As shown in FIG. 1 and FIG. 2, the gas mixer 10 further includes a gas intake pipe 200. The gas intake pipe 200 is movably coupled to the first gas intake passage 120 of the housing 100, so that a front end of the gas intake pipe 200 can enter the main body 110 through the first gas intake passage 120 and is configured to extend to over the second gas intake passage 130 and for the first gas G1 to flow through. Furthermore, the gas intake pipe 200 is partially disposed in the first gas intake passage 120, and the front end of the gas intake pipe 200 is configured to move within a range R. An exemplary coupling method of the gas intake pipe 200 and the first gas intake passage 120 will be described in detail in subsequent paragraphs.

As shown in FIG. 2, the first gas intake passage 120 has an inner diameter d1. The second gas intake passage 130 has an inner diameter d2. The gas outlet passage 140 has an inner diameter d3. The gas intake pipe 200 has an inner diameter d4. In some embodiments, in order to keep an outlet pressure of the mixed gas G3 within a required range, the inner diameter d3 of the gas outlet passage 140 is greater than or equal to the inner diameter d1 of the first gas intake passage 120, and the inner diameter d3 is less than the inner diameter d2 of the second gas intake passage 130. In order that the gas intake pipe 200 can be partially disposed in the first gas intake passage 120, the inner diameter d4 of the gas intake pipe 200 is less than the inner diameter d1 of the first gas intake passage 120. Furthermore, the main body 110 has an inner diameter D along the direction Z, as shown in FIG. 2. In some embodiments, the inner diameter D is between twice and 10 times the inner diameter d4 of the gas intake pipe 200.

In some embodiments, as shown in FIG. 2, a central axis of the first gas intake passage 120 and a central axis of the second gas intake passage 130 extend and intersect with each other. In some embodiments, an included angle between the central axis of the first gas intake passage 120 and the central axis of the second gas intake passage 130 is in a range from 60 degrees to 120 degrees. For example, the central axis of the first gas intake passage 120 extends along a horizontal direction (i.e., the direction X), and the central axis of the second gas intake passage 130 extends along a vertical direction (i.e., the direction Z). In such case, the central axis of the first gas intake passage 120 is substantially perpendicular to the central axis of the second gas intake passage 130 (i.e., the included angle is substantially equal to 90 degrees).

In some embodiments, a central axis of the gas intake pipe 200 substantially coincides with the central axis of the first gas intake passage 120. In this way, the flow direction of the first gas G1 flowing along the gas intake pipe 200 and the flow direction of the second gas G2 intersect within the range R. For example, as shown in FIG. 2, the two intersect right over the second gas intake passage 130. In some embodiments, the range R has a width W along the direction X. The width W is greater than the inner diameter d2 of the second gas intake passage 130. For example, the width W is between 1 and 1.5 times the inner diameter d2. In some embodiments, one boundary of the range R (e.g., the right boundary shown in FIG. 2) is approximately disposed at the second end of the convergent portion 141 that is connected to the gas outlet passage 140, and the other boundary of the range R (e.g., the left boundary shown in FIG. 2) is disposed between an end of the first gas intake passage 120 and an inner wall of the second gas intake passage 130.

When the gas intake pipe 200 is disposed at the position shown in FIG. 2, the first gas G1 intersects with the second gas G2 in the range R and mixes naturally after leaving the gas intake pipe 200. In this case, the mixing ratio between the first gas G1 and the second gas G2 is determined by intake flow rates of the first gas G1 and the second gas G2. For example, in embodiments where the first gas G1 includes hydrogen and the second gas G2 includes oxygen and natural gas, an intake flow rate of the second gas G2 is less than an intake flow rate of the first gas G1. For example, the intake flow rate of the second gas G2 may be between 0.7 times and 0.9 times the intake flow rate of the first gas G1.

In order to improve the gas mixing efficiency, intake pressures of the first gas G1 and the second gas G2 can be manipulated. For example, in embodiments where the first gas G1 includes hydrogen and the second gas G2 includes oxygen and natural gas, an intake pressure of the first gas G1 is greater than an intake pressure of the second gas G2. For example, the intake pressure of the first gas G1 is between 1.1 times and 1.4 times the intake pressure of the second gas G2. For example, the intake pressure of the first gas G1 may be 7 kPa, and the intake pressure of the second gas G2 may be 6 kPa.

In some embodiments, to prevent the issue of excessively high outer flame temperatures during the combustion process of the mixed gas G3 with a high hydrogen ratio, the front-end position of the gas intake pipe 200 and the flow rate ratio of the first gas G1 and the second gas G2 can be adjusted, such that the hydrogen included in the mixed gas G3 is substantially enveloped by natural gas. In other words, in the gas outlet passage 140, in the cross section formed by the direction Y and the direction Z, the volume proportion of hydrogen near the central axis of the gas outlet passage 140 is higher than the volume proportion of hydrogen near an inner wall of the gas outlet passage 140. By lowering the outer flame temperatures, an inner wall of the combustion chamber may be prevented from embrittlement caused by high-temperature hydrogen (i.e., hydrogen embrittlement), thereby extending the life of the combustion chamber and reducing nitrogen oxide (NOₓ) emissions.

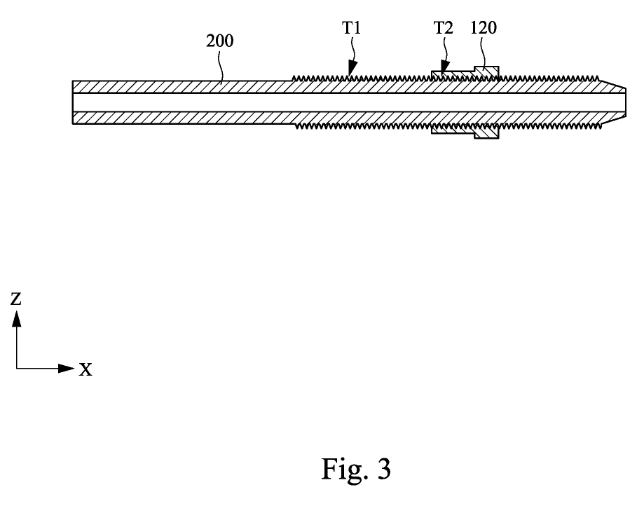

Reference is made to FIG. 3. FIG. 3 is a partial cross-sectional view of the first gas intake passage 120 and the gas intake pipe 200 of the gas mixer 10 according to some embodiments of this disclosure. In some embodiments, the gas intake pipe 200 and the first gas intake passage 120 are threadedly engaged, so that the gas intake pipe 200 can move along the direction X. For example, an outer wall of the gas intake pipe 200 has an external thread T1. An inner wall of the first gas intake passage 120 has an internal thread T2 that is configured to engage with the external thread T1. In some embodiments, the first gas intake passage 120 and the gas intake pipe 200 can be sealed using a conventional thread sealant or similar means to prevent gas from leaking from the housing 100 and enhance safety and reliability.

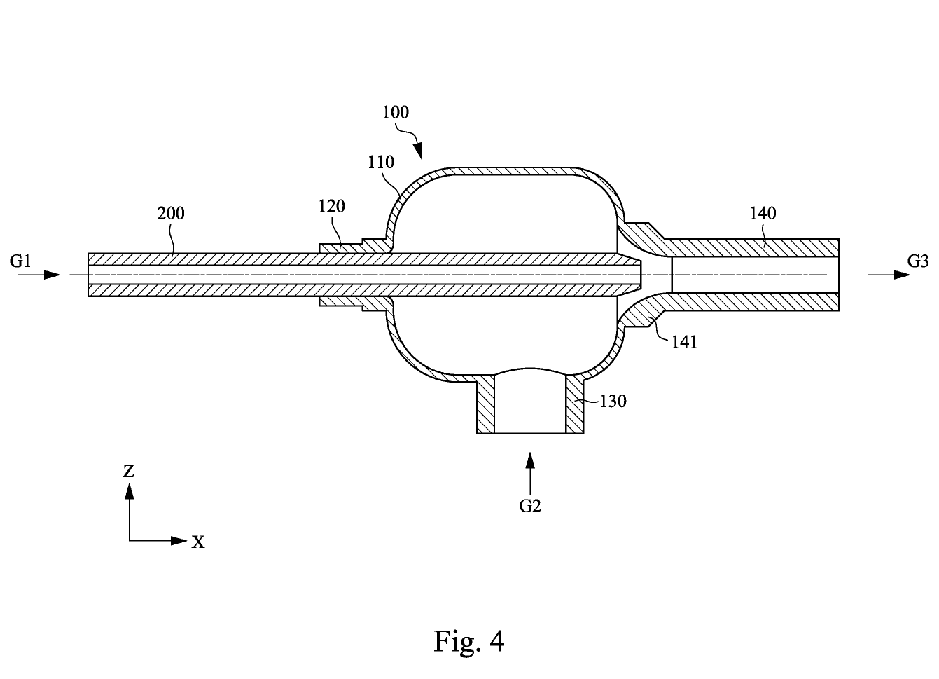

Reference is made to FIG. 4. FIG. 4 is a partial cross-sectional view of the gas mixer 10 according to some other embodiments of this disclosure. In these embodiments, the central axis of the first gas intake passage 120 and the central axis of the gas intake pipe 200 substantially coincide with the central axis of the convergent portion 141, so that the front end of the gas intake pipe 200 can extend partially into the convergent portion 141. In this way, a negative pressure is generated through the change in the cross-sectional area, so that the second gas G2 is sucked and mixed with the first gas G1. In such case, the mixing ratio between the first gas G1 and the second gas G2 is determined by the position of the front end of the gas intake pipe 200 relative to the convergent portion 141 and the Venturi effect. For example, the smaller the cross-sectional area of the convergent portion 141 where the front end of the gas intake pipe 200 is disposed, the greater the proportion of the first gas G1 in the mixed gasG3. On the contrary, the greater the cross-sectional area, the smaller the proportion. Therefore, by dynamically adjusting the front end position of the gas intake pipe 200, the ratio of the first gas G1 and the second gas G2 delivered to the combustion chamber can be instantly adjusted according to the combustion conditions during the combustion process without changing the equipment configuration.

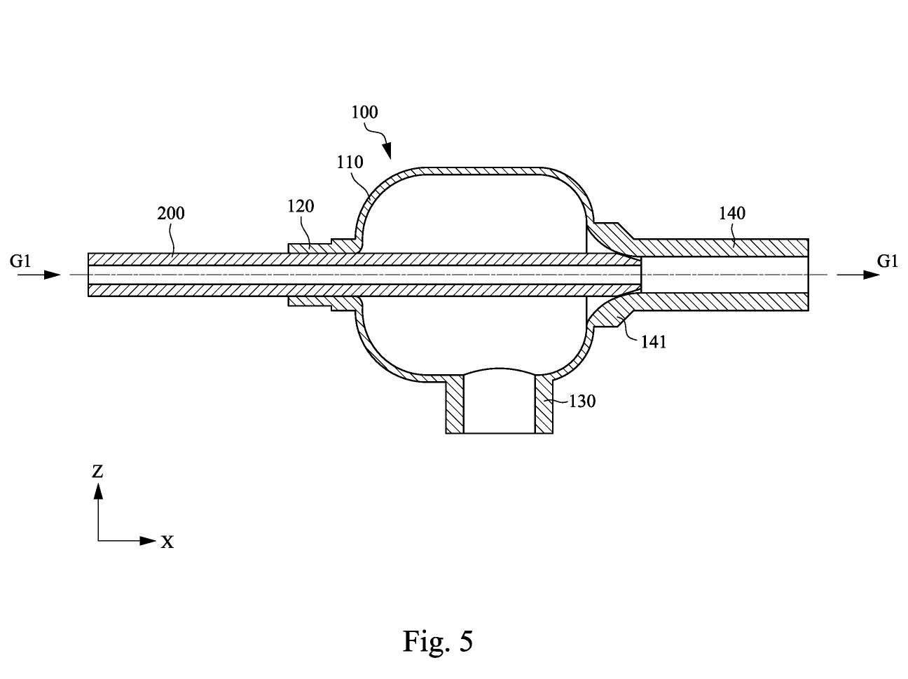

Reference is made to FIG. 5. FIG. 5 is a partial cross-sectional view of the gas mixer 10 according to some other embodiments of this disclosure. In these embodiments, the front end of the gas intake pipe 200 further extends into the convergent portion 141 and abuts against an inner wall of the convergent portion 141. In this way, the first gas G1 can be directly transported to the external combustion chamber through the convergent portion 141 and the gas outlet passage 140.

According to the foregoing recitations of the embodiments of the disclosure, it may be seen that in the gas mixer of some embodiments of the present disclosure, a first gas intake passage and a second gas intake passage with their central axes extending and intersecting are provided. Meanwhile, the gas intake pipe is movably coupled to the first gas intake passage. As a result, the front end of the gas intake pipe can extend over the second gas intake passage, so that the first gas may directly meet and mix with the second gas passing through the second gas intake passage after the first gas passes through the first gas intake passage and leaves the gas intake pipe. In addition, a convergent portion is disposed between the main body and the gas outlet passage. In this way, when the front end of the gas intake pipe extends over the second gas intake passage and into the convergent portion, the Venturi effect can be applied to adjust the mixing ratio of the first gas and the second gas. Therefore, compared with common gas mixers, the gas mixer of the present disclosure enables more precise control over gas mixing, thereby mitigating the issue of poor combustion efficiency caused by changes in gas composition.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A gas mixer, comprising:
a housing having a main body, a first gas intake passage, a second gas intake passage, and a gas outlet passage, wherein the first gas intake passage, the second gas intake passage, and the gas outlet passage are connected to the main body, and a central axis of the first gas intake passage and a central axis of the second gas intake passage extend and intersect with each other; and
a gas intake pipe movably coupled to the first gas intake passage of the housing, so that a front end of the gas intake pipe is configured to extend to over the second gas intake passage through the first gas intake passage.

2. The gas mixer of claim 1, wherein the front end of the gas intake pipe is configured to move within a range, the range has a width along a direction that is substantially perpendicular to the central axis of the second gas intake passage, and the width is greater than an inner diameter of the second gas intake passage.

3. The gas mixer of claim 2, wherein an inner diameter of the second gas intake passage is greater than an inner diameter of the first gas intake passage and is greater than an inner diameter of the gas outlet passage.

4. The gas mixer of claim 1, wherein a first gas flows into the main body through the gas intake pipe, a second gas flows into the main body through the second gas intake passage, and a first intake pressure of the first gas is greater than a second intake pressure of the second gas.

5. The gas mixer of claim 1, wherein a first gas flows into the main body through the gas intake pipe, a second gas flows into the main body through the second gas intake passage, and a second intake flow rate of the second gas is less than a first intake flow rate of the first gas.

6. The gas mixer of claim 1, wherein the gas intake pipe has an external thread, and the first gas intake passage has an internal thread configured to engage with the external thread of the gas intake pipe.

7. The gas mixer of claim 1, wherein the gas outlet passage is connected to the main body through a convergent portion, and a cross-sectional area of a first end of the convergent portion that is connected to the main body is greater than a cross-sectional area of a second end of the convergent portion that is connected to the gas outlet passage.

8. The gas mixer of claim 7, wherein a central axis of the convergent portion substantially coincides with the central axis of the first gas intake passage.

9. The gas mixer of claim 7, wherein the front end of the gas intake pipe is configured to extend at least partially into the convergent portion.

10. The gas mixer of claim 1, wherein an included angle between the central axis of the first gas intake passage and the central axis of the second gas intake passage is in a range from 60 degrees to 120 degrees.

11. The gas mixer of claim 1, wherein an inner diameter of the second gas intake passage is greater than an inner diameter of the first gas intake passage and is greater than an inner diameter of the gas outlet passage.

12. A gas mixer, comprising:
a housing having a main body, a first gas intake passage, a gas outlet passage, and a second gas intake passage, wherein the first gas intake passage is connected to a first end of the main body, the gas outlet passage is connected to a second end of the main body through a convergent portion, and the second gas intake passage is connected to a third end of the main body, wherein the second end is opposite to the first end, and the third end is between the first end and the second end; and
a gas intake pipe movably coupled to the first gas intake passage of the housing and configured to extend at least partially into the convergent portion.

13. The gas mixer of claim 12, wherein the gas intake pipe has an external thread, and the first gas intake passage has an internal thread configured to engage with the external thread of the gas intake pipe.

14. The gas mixer of claim 12, wherein a central axis of the convergent portion substantially coincides with a central axis of the first gas intake passage.

15. The gas mixer of claim 12, wherein an inner diameter of the second gas intake passage is greater than an inner diameter of the first gas intake passage and is greater than an inner diameter of the gas outlet passage.
